(19) United States
(12) Patent Application Publication
(10) Pub. No.: US 2026/0172739 A1
(43) Pub. Date: Jun. 18, 2026

(54) ADAPTIVE NOISE FLOOR REDUCTION FOR WEARABLE AUDIO DEVICES

(71) Applicant: Bose Corporation, Framingham, MA (US)

(72) Inventors: Benjamin J. Krosner, Bedford, MA (US); Shaun D. Ente, Framingham, MA (US); Masanori Honda, Northborough, MA (US)

(73) Assignee: Bose Corporation, Framingham, MA (US)

(21) Appl. No.: 18/983,872

(22) Filed: Dec. 17, 2024

(51) Int. Cl. H04R 1/10

(52) U.S. Cl. CPC H04R 1/1083; H04R 1/1008

(57) ABSTRACT

A wearable audio device including an acoustic driver, a feedforward microphone, a feedback microphone, and a controller is provided. The controller generates an aware audio signal based on a playback audio signal and an external audio signal corresponding to the feedforward microphone. The controller further generates a feedback path signal based on the aware audio signal and a feedback audio signal. The feedback audio signal corresponds to the feedback microphone. The controller further generates a noise floor reduction signal based on the feedback path signal, the playback audio signal, and the external audio signal. The controller further generates an acoustic driver signal based on feedback path signal and the noise floor reduction signal. The controller renders, via the acoustic driver, output audio based on the acoustic driver signal.

### FIELD OF THE DISCLOSURE

The present disclosure is generally directed to adaptive noise floor reduction for wearable audio devices.

### BACKGROUND

Wearable audio devices, such as audio headphones or earbuds, may implement active noise reduction (ANR) to reduce unwanted, external sounds. The ANR systems detect unwanted noise and then generate noise cancellation audio to destructively interfere with the unwanted noise. However, this process may result in an elevated audio noise floor. The noise floor refers to the level of unwanted background noise in the output audio rendered by the wearable audio device. The elevated noise floor may result from amplifying the noise floors of the components of the wearable audio device (microphones, circuit components, etc.). This elevated noise floor may be unnoticeable in loud environments or masked by other audio (music, telephone call audio, etc.) generated by the wearable audio device. However, in quiet environments when the other audio is also quiet (or even deactivated), the elevated noise floor may be noticeable and irritating to users. The elevated noise floor may be particularly annoying to users wearing the wearable audio device simply for the noise-cancellation aspect and without listening to other audio.

### SUMMARY

The present disclosure is generally directed to systems and methods for providing a wearable audio device (such as audio headphones and earbuds) with active noise reduction (ANR) augmented with adaptive noise floor reduction. The adaptive noise floor reduction is used to limit the ANR being applied to certain frequencies (such as between 500 Hz and 5 kHz) when the wearable audio device is rendering low volume audio in a quiet external environment.

The wearable audio device includes a controller, an acoustic driver, a feedback microphone, and a feedforward microphone. The feedback microphone is positioned to capture output audio rendered by the acoustic driver. The feedforward microphone is positioned on an external surface of the wearable audio device to capture external audio and generate an external audio signal. The wearable audio device also receives a playback audio signal. The playback audio signal may be provided by an external device in wired or wireless communication with the wearable audio device, such as a smartphone. The playback audio signal may include entertainment audio (such as music or an audiovisual soundtrack) telephone call audio, etc.

The playback audio signal is filtered by a playback path equalizer to generate a filtered playback signal. The external audio signal is also filtered by an aware path filter to generate a filtered external signal. The filtered playback signal and the filtered external signal are then combined to generate an aware audio signal. A feedback path signal is then generated by combining the aware audio signal with a feedback path signal corresponding to audio captured by the feedback microphone. The feedback path signal is then filtered by a feedback path filter to generate a filtered feedback signal. The feedback path filter is configured to implement ANR on the generated filtered feedback signal. A noise floor reduction signal is then generated based on the feedback path signal, the playback audio signal, and the external audio signal. The noise reduction signal is configured to reduce the ANR impact of the feedback path filter when the wearable audio device is rendering low volume audio in a quiet external environment. In particular, the impact of the ANR may be reduced between 500 Hz and 5 kHz. The filtered feedback signal is combined with the noise floor reduction signal to generate an acoustic driver signal, and the acoustic driver renders the output audio for the user to hear based on the acoustic driver signal.

The noise floor reduction signal is generated using at least two sound level meters, one for the playback audio signal and one for the external audio signal. The sound level meters may use slew rate limiters to prevent noise floor changes from being noticeable to the user. Further, prior to using the sound level meter to measure the external audio signal, the external audio signal may be filtered by a high pass filter, counteracting the elevation of the noise floor due to voices and other high frequency content. The high pass filter may have a corner frequency of at least 1 kHz.

While the noise floor reduction signal may reduce irritating or annoyingly high noise floor level, the noise reduction signal may impact the equalization applied to the playback audio signal by the playback path equalizer. Thus, to counter this impact, an equalization adjustment signal may be generated. The equalization adjustment signal is based on the sound level meter measurements of the playback audio signal and the external audio signal, as well as the filtered feedback path signal.

Generally, in one example, a wearable audio device is provided. The wearable audio device includes an acoustic driver, a feedforward microphone, a feedback microphone, and a controller.

The controller is configured to generate an aware audio signal based on a playback audio signal and an external audio signal corresponding to the feedforward microphone.

The controller is configured to generate a feedback path signal based on the aware audio signal and a feedback audio signal. The feedback audio signal corresponds to the feedback microphone.

The controller is further configured to generate a noise floor reduction signal based on the feedback path signal, the playback audio signal, and the external audio signal.

The controller is further configured to generate the acoustic driver signal based on feedback path signal and the noise floor reduction signal.

The controller is further configured to render, via the acoustic driver, output audio based on the acoustic driver signal.

According to an example, the noise floor reduction signal is generated by: (1) generating, via a playback sound level meter, a playback sound level based on the playback audio signal; (2) filtering, via a high pass filter, the external audio signal to generate a filtered external signal; (3) generating, via an external sound level meter, an external sound level based on the filtered external signal; and (4) generating the noise floor reduction signal based on the playback sound level, the external sound level, and the feedback path signal.

According to an example, the playback sound level meter generates the external sound level via a first slew rate limiter.

According to an example, the external sound level meter generates the playback sound level via a second slew rate limiter.

According to an example, the high pass filter has a corner frequency of at least 1 kHz.

According to an example, the feedback path signal is further generated based on an equalizer adjustment signal.

According to an example, the equalizer adjustment signal is generated based on the playback sound level, the external sound level, and the aware audio signal.

According to an example, the controller is configured to apply a first low pass filter to the playback sound level, and to apply a second low pass filter to the external sound level.

According to an example, the aware audio signal is generated by: (1) filtering, via a playback path equalizer, the playback audio signal to generate a filtered playback signal; (2) filtering, via an aware path filter, the external audio signal to generate a filtered external signal; and (3) combining the filtered playback signal and the filtered external signal to generate the aware audio signal.

According to an example, the acoustic driver signal is generated by: (1) filtering, via a feedback path filter, the feedback path signal to generate a filtered feedback signal; and (2) combining the filtered feedback signal with the noise floor reduction signal to generate the acoustic driver signal.

Generally, in another example, a method for rendering output audio via a wearable audio device is provided. The method includes generating an aware audio signal based on a playback audio signal and an external audio signal corresponding to a feedforward microphone of the wearable audio device.

The method further includes generating a feedback path signal based on the aware audio signal and a feedback audio signal. The feedback audio signal corresponds to a feedback microphone of the wearable audio device.

The method further includes generating a noise floor reduction signal based on the feedback path signal, the playback audio signal, and the external audio signal.

The method further includes generating an acoustic driver signal based on feedback path signal and the noise floor reduction signal.

The method further includes rendering, via an acoustic driver of the wearable audio device, output audio based on the acoustic driver signal.

According to an example, the noise floor reduction signal is generated by: (1) generating, via a playback sound level meter, a playback sound level based on the playback audio signal; (2) filtering, via a high pass filter, the external audio signal to generate a filtered external signal; (3) generating, via an external sound level meter, an external sound level based on the filtered external signal; and (4) generating the noise floor reduction signal based on the playback sound level, the external sound level, and the feedback path signal.

According to an example, the playback sound level meter generates the external sound level via a first slew rate limiter.

According to an example, the external sound level meter generates the playback sound level via a second slew rate limiter.

According to an example, the high pass filter has a corner frequency of at least 1 kHz.

According to an example, the feedback path signal is further generated based on an equalizer adjustment signal.

According to an example, the equalizer adjustment signal is generated based on the playback sound level, the external sound level, and the aware audio signal.

According to an example, the method further includes applying a first low pass filter to the playback sound level and applying a second low pass filter to the external sound level.

According to an example, the aware audio signal is generated by: (1) filtering, via a playback path equalizer, the playback audio signal to generate a filtered playback signal; (2) filtering, via an aware path filter, the external audio signal to generate a filtered external signal; and (3) combining the filtered playback signal and the filtered external signal to generate the aware audio signal.

According to an example, the acoustic driver signal is generated by: (1) filtering, via a feedback path filter, the feedback path signal to generate a filtered feedback signal; and (2) combining the filtered feedback signal with the noise floor reduction signal to generate the acoustic driver signal.

In various implementations, a processor or controller can be associated with one or more storage media (generically referred to herein as “memory,” e.g., volatile and non-volatile computer memory such as ROM, RAM, PROM, EPROM, and EEPROM, floppy disks, compact disks, optical disks, magnetic tape, Flash, OTP-ROM, SSD, HDD, etc.). In some implementations, the storage media can be encoded with one or more programs that, when executed on one or more processors and/or controllers, perform at least some of the functions discussed herein. Various storage media can be fixed within a processor or controller or can be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also can appear in any disclosure incorporated by reference should be accorded a meaning most consistent with the particular concepts disclosed herein.

Other features and advantages will be apparent from the description and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is an isometric view of a wearable audio device, in accordance with an example.

FIG. 2 is a block diagram of hardware aspects of a system for rendering audio, in accordance with an example.

FIG. 3 is a functional block diagram of aspects of a system for rendering output audio, in accordance with an example.

FIG. 4 is a functional block diagram of aspects of a system for generating a noise floor reduction signal, in accordance with an example.

FIG. 5 is a functional block diagram of aspects of a system for generating an equalization adjustment signal, in accordance with an example.

FIG. 6 is a flow chart of a method for rendering output audio via a wearable audio device, in accordance with an example.

### DETAILED DESCRIPTION

The present disclosure is generally directed to systems and methods for providing a wearable audio device (such as audio headphones and earbuds) with active noise reduction (ANR) augmented with adaptive noise floor reduction. The adaptive noise floor reduction is used to limit the ANR being applied to certain frequencies when the wearable audio device is rendering low volume audio in a quiet external environment. The wearable audio device includes a controller, an acoustic driver, a feedback microphone, and a feedforward microphone. The feedback microphone is positioned to capture output audio rendered by the acoustic driver. The feedforward microphone is positioned on an external surface of the wearable audio device to capture external audio and generate an external audio signal. The wearable audio device also receives a playback audio signal. The playback audio signal is filtered by a playback path equalizer to generate a filtered playback signal. The external audio signal is also filtered by an aware path filter to generate a filtered external signal. The filtered playback signal and the filtered external signal are then combined to generate an aware audio signal. A feedback path signal is then generated by combining the aware audio signal with a feedback path signal corresponding to audio captured by the feedback microphone. The feedback path signal is then filtered by feedback path filter to generate a filtered feedback signal. The feedback path filter is configured to implement ANR on the generated filtered feedback signal. A noise floor reduction signal is then generated based on the feedback path signal, the playback audio signal, and the external audio signal. The noise reduction signal is configured to reduce the ANR impact of the feedback path filter when the wearable audio device is rendering low volume audio in a quiet external environment. The filtered feedback signal is combined with the noise floor reduction signal to generate an acoustic driver signal, and the acoustic driver renders the output audio for the user to hear based on the acoustic driver signal.

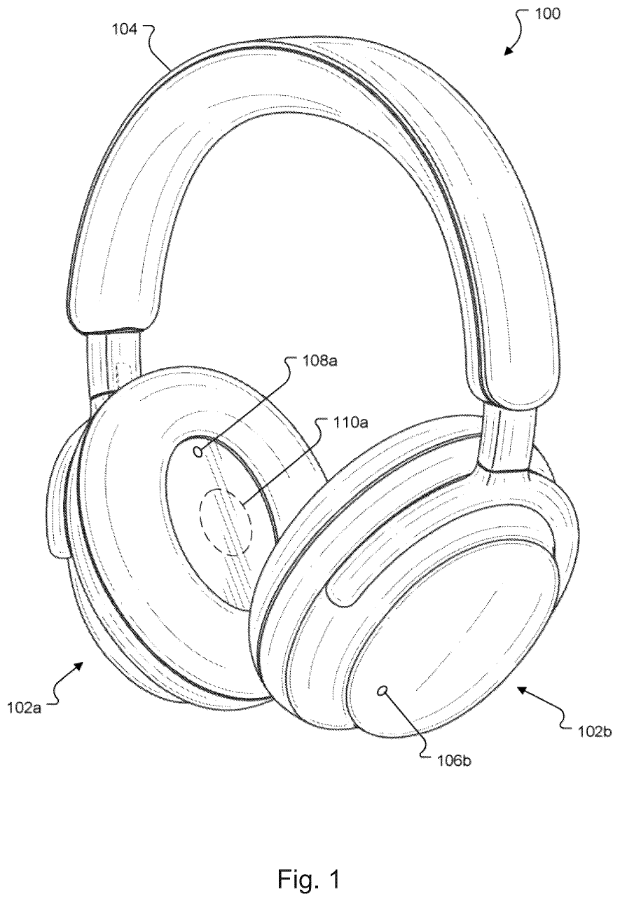

The following description should be read in view of FIGS. 1-6.

The term “wearable audio device,” as used in this application, in addition to including its ordinary meaning or its meaning known to those skilled in the art, is intended to mean a device that fits around, on, in, or near an ear (including open-ear audio devices worn on the head or shoulders of a user) and that radiates acoustic energy into or towards the ear. Wearable audio devices are sometimes referred to as headphones, earphones, earpieces, headsets, earbuds or sport headphones, and can be wired or wireless. A wearable audio device includes an acoustic driver to transduce audio signals to acoustic energy. The acoustic driver can be housed in an earcup. While some of the figures and descriptions following can show a single wearable audio device, having a pair of earcups (each including an acoustic driver) it should be appreciated that a wearable audio device can be a single stand-alone unit having only one earcup. Each earcup of the wearable audio device can be connected mechanically to another earcup or headphone, for example by a headband and/or by leads that conduct audio signals to an acoustic driver in the ear cup or headphone. A wearable audio device can include components for wirelessly receiving audio signals. A wearable audio device can include components of an active noise reduction (ANR) system. Wearable audio devices can also include other functionality such as a microphone so that they can function as a headset. While the non-limiting example of FIG. 1 depicts the wearable audio device 100 as an audio headset with a pair of ear cups, the wearable audio device 100 described below may be any of the aforementioned types of devices.

FIG. 1 illustrates a wearable audio device 100 embodied as a headset. The headset includes a right earpiece 102a and a left earpiece 102b, intercoupled by a supporting structure 104 (e.g., a headband) to be worn by a user. In some examples, two earpieces 102 may be independent of each other, not intercoupled by a supporting structure. In some cases, the two earpieces 102 may be in the form of in-ear headphones (e.g., earbuds). Each earpiece 102 may include one or more microphones, such as a feedforward microphone 106 and/or a feedback microphone 108. The feedforward microphone 106 may be configured to sense acoustic signals external to the earpiece 102 when properly worn, e.g., to detect acoustic signals in the surrounding environment before they reach the user's ear. The feedback microphone 108 may be configured to sense acoustic signals internal to an acoustic volume formed with the user's ear when the earpiece 102 is properly worn, e.g., to detect the acoustic signals reaching the user's ear. Each earpiece also includes an acoustic driver 110a, 110b (collectively 110), which is a transducer for conversion of, e.g., an electrical signal, into an acoustic signal that the user may hear. In various examples, one or more drivers may be included in an earpiece, and an earpiece may in some cases include only a feedforward microphone or only a feedback microphone. Examples of wearable audio devices 100 are described in U.S. Pat. No. 11,996,078, which is incorporated herein by reference in its entirety.

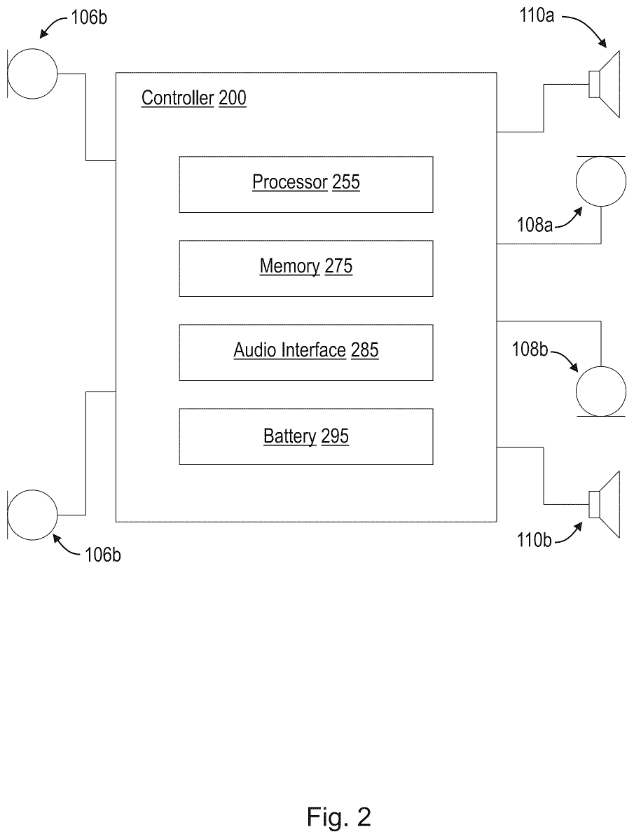

Shown in FIG. 2 is an example of a controller 200 that may be physically housed somewhere on or within the wearable audio device 100. The controller 200 may include a processor 255, a memory 275, an audio interface 285, and a battery 295. The controller 200 may be coupled to one or more feedforward microphone(s) 106a, 106b, feedback microphone(s) 108a, 108b, and/or acoustic driver(s) 110a, 110b, in various examples. In one example, a first feedforward microphone 106a, a first feedback microphone 108a, and a first acoustic driver 110a may be arranged in a right earpiece 102a (as shown in FIG. 1), while a second feedforward microphone 106b, a second feedback microphone 108b, and a second acoustic driver 110b may be arranged in a left earpiece 102b (as also shown in FIG. 1). In various examples, the audio interface 285 may be a wired or a wireless interface for receiving audio signals, such as a playback audio signal, and may include further interface functionality, such as a user interface for receiving user inputs and/or configuration options. In various examples, the battery 295 may be replaceable and/or rechargeable. In various examples, the controller 200 may be powered via means other than or in addition to the battery 295, such as by a wired power supply or the like. In some examples, a system may be designed for noise reduction only and may not include an audio interface 285 to receive a playback signal.

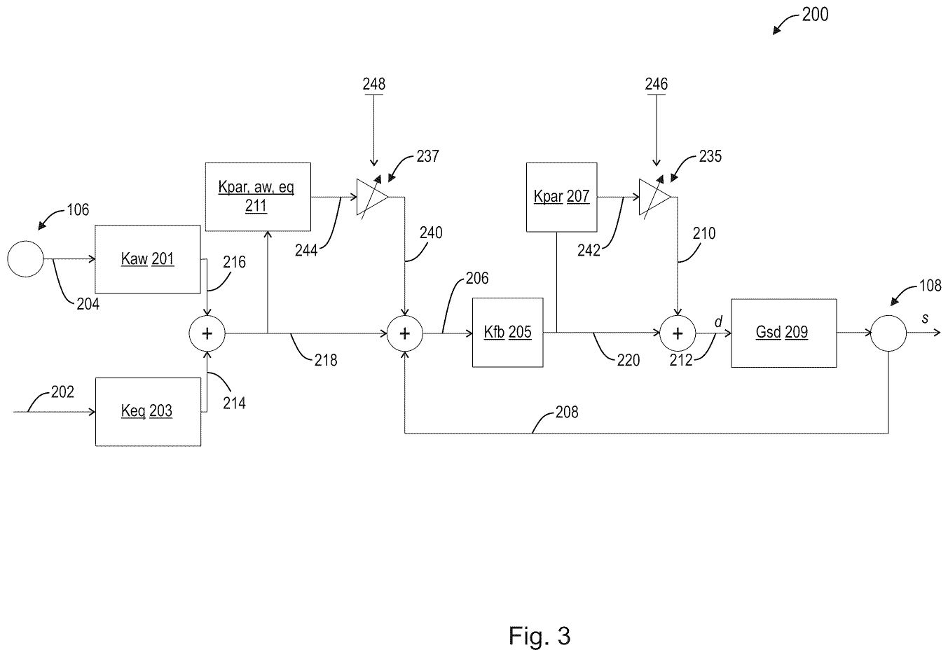

FIG. 3 is a functional block diagram representing various aspects of the controller 200. The controller 200 implements as system for rendering output audio via the wearable audio device 100. The aspects depicted in and described in relation to FIG. 3 may be executed by the processor 255 of the controller 200 and/or stored in the memory 275 of the controller 200. As shown in FIG. 3, the controller 200 receives a playback audio signal 202. The playback audio signal 202 represents the audio the user wishes to hear via the wearable audio device, such as entertainment audio (music, spoken word, etc.) or telephone call audio. The playback audio signal 202 may be received via the audio interface 285 using any combination of wired or wireless connection. For example, the controller 200 may receive the playback audio signal 202 from a smartphone via Bluetooth transmission. The playback audio signal 202 may be filtered by a playback path equalizer 203 (labelled K_{eq}) to generate a filtered playback signal 214. The frequency response of the playback path equalizer 203 may be programmed by the user according to their preferred audio settings (i.e. increased bass output, reduced high frequency output, etc.).

Further, the controller 200 also receives an external audio signal 204 via the feedforward microphone 106. The external audio signal 204 represents environmental sounds present around the wearable audio device 100. This external audio signal 204 enables the wearable audio device 100 to operate in an “aware mode” where the user may wish to hear external sounds even when wearing the wearable audio device 100. For example, while wearing a wearable audio device 100 which greatly reduces the level of external sounds audible to the user due to the physical shape of the earpieces 102, a user may wish to be cognizant of the sounds of their environment for safety purposes. The external audio signal 204 is filtered by an aware path filter 201 (labelled K_{aw}) to generate a filtered external signal 216. The frequency response of the aware path filter 201 may be programmed according to one or more predetermined settings. The filtered playback signal 214 is then combined with the filtered external signal 216 to generate an aware audio signal 218. For example, the aware audio signal 218 may contain data representing the music the user is streaming from their smartphone as well as data representing aspects of environmental sounds present during an outdoor walk.

The controller 200 receives a feedback audio signal 208 via the feedback microphone 106. The feedback audio signal 208 represents an approximation of the audio heard by the user. The feedback audio signal 208 is combined with the aware audio signal 218 to generate a feedback path signal 206. The feedback path signal 206 is filtered by a feedback path filter 205 to generate a filtered feedback path signal 220. The frequency response of the feedback path filter 205 may be programmed according to one or more predetermined settings.

Combining the feedback audio signal 208 with the aware audio signal 218 and then filtering the feedback path signal 206 using the feedback path filter 205 may enable active noise reduction (ANR) by removing unwanted sound captured by the feedback microphone 108. However, this ANR can result in an elevated noise floor (such as due to the noise floor of the feedback microphone 108 or the elements of the controller 200) which may be audible when the volume of the playback audio signal 202 and the external audio signal 204 are low.

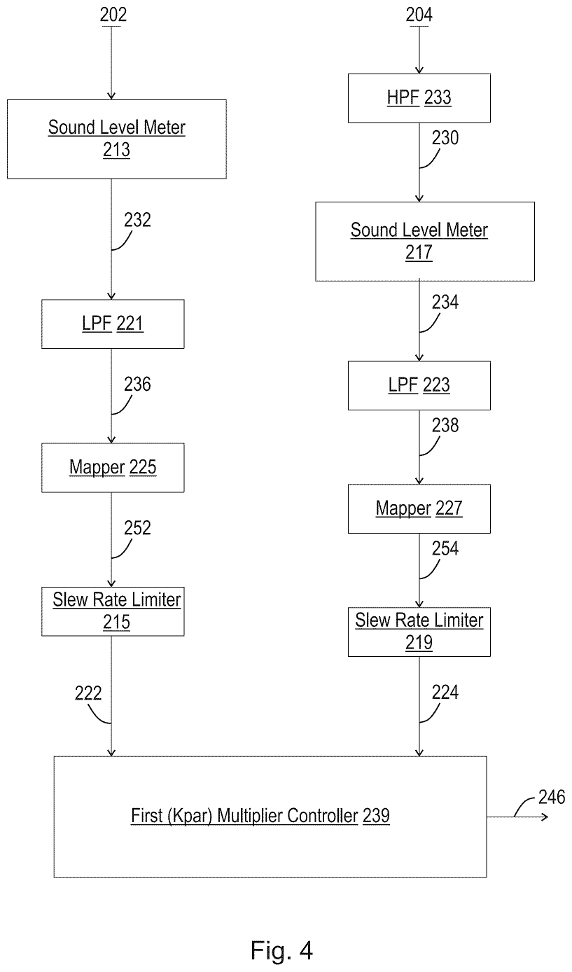

To counteract this elevated noise floor, the controller 200 implements a first parallel path filter 207 (labelled as Kₚₐᵣ) and a first dynamic multiplier 235. The frequency response of the first parallel path filter 207 is predetermined to reduce the elevated noise floor. The first dynamic multiplier 235 has a variable gain ranging from 0 and 1 to control the intensity of the noise floor reduction signal 210 based on a first gain control signal 246. As will be shown in FIG. 4, the first gain control signal 246 is generated based on the sound levels of the playback audio signal 202 and the external audio signal 204. For example, if the sound levels associated with both the playback audio signal 202 and the external audio signal 204 are both below one or more thresholds, the noise floor reduction signal 210 effectively counteracts the ANR in certain frequency ranges (such as from 500 Hz to 5 kHz), thereby implementing a notch in the ANR frequency response. If one of the sound levels are above one or more thresholds and are there high enough to effectively mask the elevated noise floor, the noise floor reduction is reduced or effectively disabled. In some examples, the dynamic multiplier 235 may be implemented as a variable gain amplifier. The first parallel path filter 207 receives the filtered feedback path signal 220 and generates a first parallel path signal 242. The noise floor reduction signal 210 is then multiplied by a gain of the dynamic multiplier 235 to generate a noise floor reduction signal 210.

As further shown in FIG. 3, the filtered feedback path signal 220 and the noise floor reduction signal 210 are then combined to generate an acoustic driver signal 212 (labelled d). The acoustic driver signal 212 is provided to acoustic driver 110 (not shown in FIG. 3). Accordingly, the acoustic driver 110 renders output audio (such as music, telephone call audio, etc.) for the user to hear based on the acoustic driver signal 212. Further, audio signal s represents the audio actually received by the eardrum of the user. Thus, transfer function 209 (labelled G_{sd}) represents the impact of the user's ear and/or the wearable audio device 100 upon the output audio rendered by the acoustic driver 110. The output audio is captured by the feedback microphone 108 and results in the feedback audio signal 208 as described above.

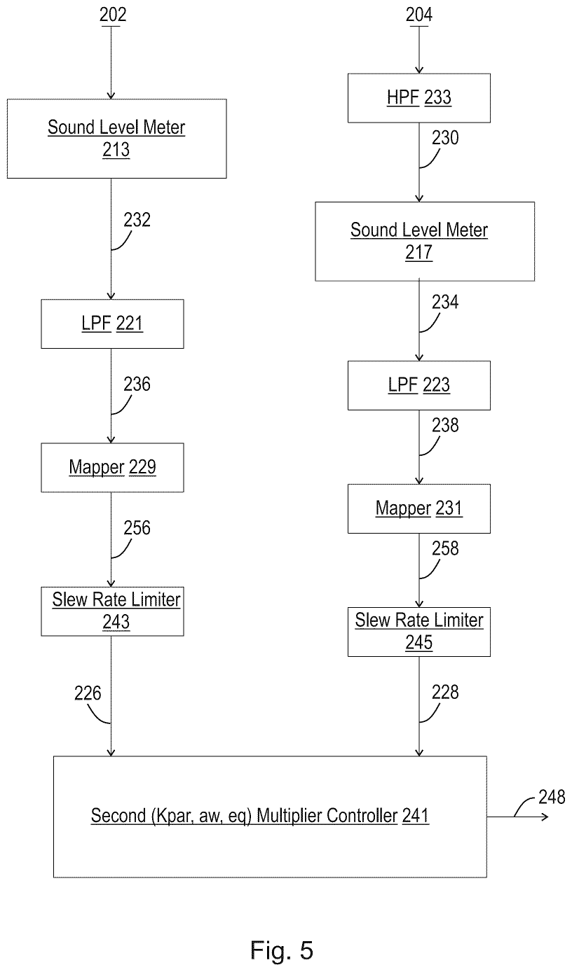

Further, FIG. 3 also illustrates a second parallel path filter 211 (labeled K_{par, aw, eq}) and a second dynamic multiplier 237. While the noise floor reduction signal 210 may be used to reduce the audible noise floor of the acoustic driver signal 212, in some cases this noise floor reduction signal 210 may impact the equalization of the output audio. For example, some users have very specific equalization settings to subjectively optimize music for their particular preferences. The noise floor reduction signal 210 may prevent the music from being rendered according to the desired equalization settings. Accordingly, the second parallel path filter 211 generates a second parallel path signal 244. An equalization adjustment signal 240 is then generated by multiplying the second parallel path signal 244 by the gain of the second dynamic multiplier. Like the first parallel path filter 207, the second parallel path filter 211 may also have a predetermined frequency response to counter the equalization impact of the noise floor reduction signal 210. The second dynamic multiplier 237 has a variable gain ranging from 0 and 1 to control the intensity of the noise floor reduction based on a second gain control signal 248. As will be shown in FIG. 5, the second gain control signal 248 is generated based on the sound levels of the playback audio signal 202 and the external audio signal 204. For example, if the sound levels indicate that noise floor reduction is required, the gain of the second dynamic multiplier 237 may be 1. If the sound levels indicate that noise floor reduction is required, the gain of the second dynamic multiplier 237 may be 0. The feedback path signal 206 is then generated by combining the aware audio signal 218, the feedback audio signal 208, and the equalization adjustment signal 240.

FIG. 4 illustrates how the first gain control signal 246 is generated. As previously described, the noise floor adjustment signal 210 is configured to reduce the audible noise floor of the acoustic driver signal 212 in quiet conditions, such as when the sound levels associated with both the playback audio signal 202 and the external audio signal 204 are low. The first gain control signal 246 determines the amplitude of the noise floor adjustment signal 210. As shown in FIG. 4, a playback sound level meter (SLM) 213 generates a playback sound level 232 based on the playback audio signal 202.

Further, a high pass filter 233 processes the external audio signal 204 to generate a high pass external signal 230. The high pass filter 233 is used to allow the subsequent sound level measurements to be focused on the high frequency ranges, which may include human voices. In some examples, the high pass filter 233 may have a corner frequency of at least 1 kHz. An external SLM 217 then generates an external sound level 234 based on the high pass external signal 230.

The playback sound level 232 is then smoothed by a first low pass filter 221 to generate a smoothed playback level 236. Similarly, the external sound level 234 is then smoothed by a first low pass filter 221 to generate a smoothed external level 238. Smoothing out the sound levels 232, 234 of the playback audio signal 202 and the external audio signal 204 removes transients from the sound levels 232, 234, thereby avoiding responses to transient events.

The smoothed playback level 236 is provided to a first noise reduction mapper 225 to generate a playback noise floor reduction gain 252. The first noise reduction mapper 225 utilizes a look-up table to determine the gain (ranging from 0 to 1) of the first dynamic multiplier 235 required to reduce the noise floor of the acoustic driver signal 212 based on the sound level of the playback audio signal 202. For example, if the sound level of the playback audio signal 202 is very low, significant noise floor reduction may be required to prevent the noise floor from being audible to the user. However, if the sound level of the playback audio signal 202 is very high, noise floor reduction may not be required.

Similarly, the smoothed external level 238 is provided to a second noise reduction mapper 227 to generate an external noise floor reduction gain 254. The second noise reduction mapper 227 utilizes another look-up table to determine the gain of the first dynamic multiplier 235 (ranging from 0 to 1) required to reduce the noise floor of the acoustic driver signal 212 based on the sound level of the external audio signal 204. For example, if the sound level of the external audio signal 204 is very low, significant noise floor reduction may be required. However, if the sound level of the external audio signal 204 is very high, noise floor reduction may not be required.

The playback noise floor reduction gain 252 is then processed by a first slew rate limiter 215 to generate a rate limited playback noise reduction gain 222. The first slew rate limiter 215 prevents the gain 222 from changing too rapidly. The slew rate of the implemented by the slew rate limiter 215 may range from 0.1 gain/second to 1.0 gain/second. Similarly, the external noise floor reduction gain 254 is then processed by a second slew rate limiter 219 to generate a rate limited external noise floor gain 224.

A first multiplier controller 239 receives the rate limited playback noise reduction gain 222 and the rate limited external noise reduction gain 224 and generates the first gain control signal 246. In some examples, the value of the gain control signal 246 may simply be the lower value of the rate limited playback noise reduction gain 222 and the rate limited external noise reduction gain 224. For example, a quiet playback audio signal 202 may require a gain of 0.7 to reduce the noise floor, while loud external audio signal 204 may only require a gain of 0.1, as much of the noise floor will be masked by the external sounds. Thus, the first gain control signal 246 may implement a gain of 0.1. In other examples, the first gain control signal 246 could be an average of the rate limited playback noise reduction gain 222 and the rate limited external noise reduction gain.

FIG. 5 illustrates how the second gain control signal 246 is generated. As previously described, the equalization adjustment signal 240 is configured to compensate for any equalization changes which may occur due to the noise floor reduction signal 210. The second gain control signal 246 determines the amplitude of the equalization adjustment signal 240. As shown in FIG. 5, the smoothed playback level 236 and the smoothed external level 238 may be generated in the same manner shown in FIG. 4. The smoothed playback level 236 is then provided to a first equalization mapper 229 to generate a playback equalization gain 256. Further, the smoothed external level 238 is provided to a second equalization mapper 231 to generate an external equalization gain 258. The mappers 229, 231 each incorporate look-up tables which anticipate the effects of the noise floor reduction signal 210 and generate corresponding equalization gains 256, 258 to counter these effects.

The playback equalization gain 256 is then processed by a third slew rate limiter 243 to generate a rate limited playback equalization gain 226. The third slew rate limiter 243 prevents the gain 226 from changing too rapidly. The slew rate of the implemented by the third slew rate limiter 243 may range from 0.1 gain/second to 1.0 gain/second. Similarly, the external equalization gain 258 is then processed by a fourth slew rate limiter 245 to generate a rate limited external equalization gain 228.

A second multiplier controller 241 receives the rate limited playback equalization gain 226 and rate limited external equalization gain 228 and generates the second gain control signal 248. In some examples, the value of the second gain control signal 248 may simply be the lower value of the rate limited gains 226, 228. In other examples, the second gain control signal 248 could be an average of the rate limited gains 226, 228.

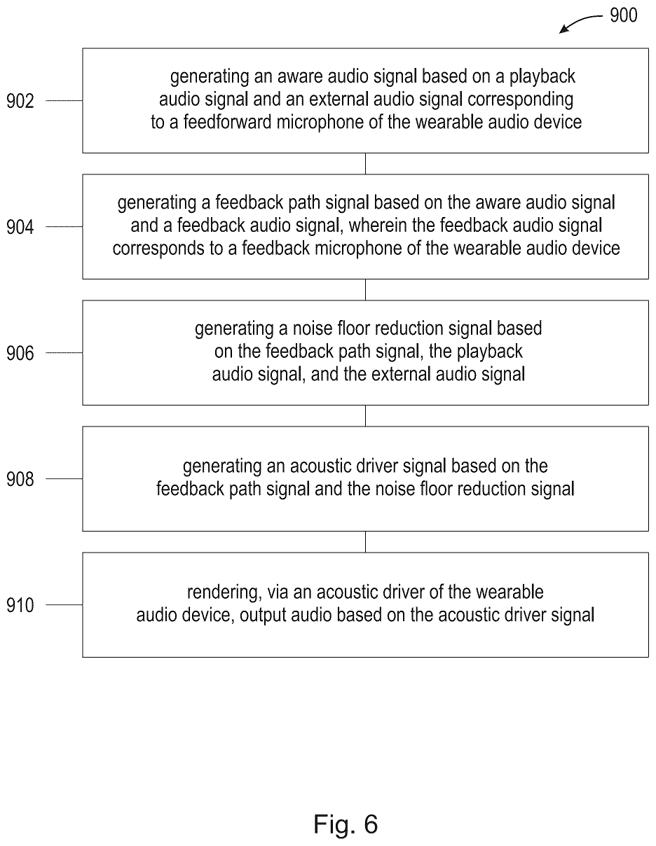

FIG. 6 is a flow chart of a method 900 for rendering output audio via a wearable audio device 100. The method 900 includes, in step 902, generating an aware audio signal 218 based on a playback audio signal 202 and an external audio signal 204 corresponding to a feedforward microphone 106 of the wearable audio device 100.

The method 900 further includes, in step 904, generating a feedback path signal 206 based on the aware audio signal 218 and a feedback audio signal 208. The feedback audio signal 208 corresponds to a feedback microphone 108 of the wearable audio device 100.

The method 900 further includes, in step 906, generating a noise floor reduction signal 210 based on the feedback path signal 206, the playback audio signal 202, and the external audio signal 204.

The method 900 further includes, in step 908, generating an acoustic driver signal 212 based on the feedback path signal 206 and the noise floor reduction signal 210.

The method 900 further includes rendering, via the acoustic driver 110 of the wearable audio device 100, output audio based on the acoustic driver signal 212.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

What is claimed is:

1. A wearable audio device comprising an acoustic driver, a feedforward microphone, a feedback microphone, and a controller, wherein the controller is configured to:
generate an aware audio signal based on a playback audio signal and an external audio signal corresponding to the feedforward microphone;
generate a feedback path signal based on the aware audio signal and a feedback audio signal, wherein the feedback audio signal corresponds to the feedback microphone; and
generate a noise floor reduction signal based on the feedback path signal, the playback audio signal, and the external audio signal;
generate the acoustic driver signal based on the feedback path signal and the noise floor reduction signal; and
render, via the acoustic driver, output audio based on the acoustic driver signal.

2. The wearable audio device of claim 1, wherein the noise floor reduction signal is generated by:
generating, via a playback sound level meter, a playback sound level based on the playback audio signal;
filtering, via a high pass filter, the external audio signal to generate a filtered external signal;
generating, via an external sound level meter, an external sound level based on the filtered external signal; and
generating the noise floor reduction signal based on the playback sound level, the external sound level, and the feedback path signal.

3. The wearable audio device of claim 2, wherein the playback sound level meter generates the external sound level via a first slew rate limiter.

4. The wearable audio device of claim 2, wherein the external sound level meter generates the playback sound level via a second slew rate limiter.

5. The wearable audio device of claim 2, wherein the high pass filter has a corner frequency of at least 1 kHz.

6. The wearable audio device of claim 2, wherein the feedback path signal is further generated based on an equalizer adjustment signal.

7. The wearable audio device of claim 6, wherein the equalizer adjustment signal is generated based on the playback sound level, the external sound level, and the aware audio signal.

8. The wearable audio device of claim 2, wherein the controller is configured to apply a first low pass filter to the playback sound level, and to apply a second low pass filter to the external sound level.

9. The wearable audio device of claim 1, wherein the aware audio signal is generated by:
filtering, via a playback path equalizer, the playback audio signal to generate a filtered playback signal;
filtering, via an aware path filter, the external audio signal to generate a filtered external signal; and
combining the filtered playback signal and the filtered external signal to generate the aware audio signal.

10. The wearable audio device of claim 1, wherein the acoustic driver signal is generated by:
filtering, via a feedback path filter, the feedback path signal to generate a filtered feedback signal; and
combining the filtered feedback signal with the noise floor reduction signal to generate the acoustic driver signal.

11. A method for rendering output audio via a wearable audio device, comprising
generating an aware audio signal based on a playback audio signal and an external audio signal corresponding to a feedforward microphone of the wearable audio device;
generating a feedback path signal based on the aware audio signal and a feedback audio signal, wherein the feedback audio signal corresponds to a feedback microphone of the wearable audio device;
generating a noise floor reduction signal based on the feedback path signal, the playback audio signal, and the external audio signal;
generating an acoustic driver signal based on the feedback path signal and the noise floor reduction signal; and
rendering, via an acoustic driver of the wearable audio device, output audio based on the acoustic driver signal.

12. The method of claim 11, wherein the noise floor reduction signal is generated by:
generating, via a playback sound level meter, a playback sound level based on the playback audio signal;
filtering, via a high pass filter, the external audio signal to generate a filtered external signal;
generating, via an external sound level meter, an external sound level based on the filtered external signal; and
generating the noise floor reduction signal based on the playback sound level, the external sound level, and the feedback path signal.

13. The method of claim 12, wherein the playback sound level meter generates the external sound level via a first slew rate limiter.

14. The method of claim 12, wherein the external sound level meter generates the playback sound level via a second slew rate limiter.

15. The method of claim 12, wherein the high pass filter has a corner frequency of at least 1 kHz.

16. The method of claim 12, wherein the feedback path signal is further generated based on an equalizer adjustment signal.

17. The method of claim 16, wherein the equalizer adjustment signal is generated based on the playback sound level, the external sound level, and the aware audio signal.

18. The method of claim 12, wherein a first low pass filter is applied to the playback sound level and wherein a second a second low pass filter to the external sound level.

19. The method of claim 11, wherein the aware audio signal is generated by:
filtering, via a playback path equalizer, the playback audio signal to generate a filtered playback signal;
filtering, via an aware path filter, the external audio signal to generate a filtered external signal; and
combining the filtered playback signal and the filtered external signal to generate the aware audio signal.

20. The method of claim 11, wherein the acoustic driver signal is generated by:
filtering, via a feedback path filter, the feedback path signal to generate a filtered feedback signal; and
combining the filtered feedback signal with the noise floor reduction signal to generate the acoustic driver signal.
